(19) United States
(12) Patent Application Publication
(10) Pub. No.: US 2019/0060952 A1
(43) Pub. Date: Feb. 28, 2019

(54) STRIP COMPONENT

(71) Applicant: Dura Automotive Holdings U.K., Ltd, Birmingham (GB)

(72) Inventors: Patrick Maifeld, Iserlohn (DE); Torsten Hundt, Neuenrade (DE); Jan Stegemann, Neuenrade (DE)

(21) Appl. No.: 16/106,674

(22) Filed: Aug. 21, 2018

(30) Foreign Application Priority Data
Aug. 22, 2017 (EP) 17187336.7

(51) Int. Cl. B05D 5/06; B60R 13/06; B60R 13/02; B60R 13/04; B05D 1/38

(52) U.S. Cl. CPC B05D 5/06; B60R 13/06; B05D 1/38; B60R 13/04; B60R 13/02

(57) ABSTRACT

In order to produce a first decorative surface portion having a first visual appearance and a second decorative surface portion having a second visual appearance differing from the first visual appearance in a strip component produced from a basic material, it is proposed to produce the second visual appearance of the second decorative surface portion through an intermediate treatment process acting directly on the basic material itself and limited in its application to the second decorative surface portion, visually modifying the surface of the second decorative surface portion, and then to subject the strip component to uniform finishing by anodizing.

### TECHNICAL FIELD

The invention relates to a strip component for a motor vehicle having an externally visible decorative surface when correctly fitted to the motor vehicle.

### BACKGROUND

The invention relates to a strip component wherein the decorative surface comprises a first decorative surface portion having a first visual appearance and a second decorative surface portion having a second visual appearance differing from the first visual appearance, wherein the strip component is produced from a preferably metallic basic material and the surface of the basic material itself contributes both to the first visual appearance of the first decorative surface portion and to the second visual appearance of the second decorative surface portion. The invention further relates to a method for producing such a strip component.

Strip components which are used for decorative purposes are known in the automotive industry. Such strip components are used externally particularly at the transition between components, such as the transition between window glass and a door bodywork or as a frame strip enclosing glazed areas. Accordingly, the strip component may be, in particular, a trim strip such as a window frame strip, for example, a window channel cover strip to be mounted onto a door sill of a vehicle door or a trim strip of a windshield frame. It may also be a cover strip, however, such as a column cover or some other decorative strip. The strip component may furthermore also be a roof rail. The strip component may furthermore be intended both for fitting in the vehicle interior and as a strip component to be fitted to the vehicle exterior.

A decorative surface is taken to mean a component surface of the strip component which is outwardly visible when the strip component is correctly fitted to the motor vehicle and which forms a trim surface and is intended to contribute conspicuously to the visual appearance of the motor vehicle or the motor vehicle interior.

In addition to the machining of a component surface of such a metallic strip component to form a decorative surface (for example polishing, matt-finishing, brushing) and the application of an additional layer of material (for example, by painting, chromium plating), (electro)chemical methods for treating the component surface contributing substantially to the decorative surface are also known. Frequently used techniques are anodizing of the component surface, in particular providing the component surface with an anodized coating. (Electro)chemical methods such as etching or electropolishing are fundamentally also known.

Even though such strip components purposely used as design elements are thoroughly suited to visually defining the external or interior appearance of a motor vehicle, and produce or at least reinforce a certain general overall visual impression, such as a refined appearance through the use of chromium-plated or highly polished strips, or a more sporty appearance through the use of black-painted or black-anodized decorative surfaces, the appearance of the strip component is in itself static, that is to say constant and uniform over the length of the decorative surface.

The publication EP 2 705 988 A1 discloses a strip component, the decorative surface of which, formed by a one-piece component surface, comprises two decorative surface portions of visually differing design. To produce the strip component, however, it is necessary to apply layers of material and protective coatings, some of which also have to be removed again in order to reveal a first layer of material again, covered by a second layer of material, through subsequent removal of the second layer of material. The method is therefore complicated and requires a large number of machining operations.

### SUMMARY

The object of the invention is to provide a strip component of the aforesaid type which visually has an intrinsically more dynamic appearance. The intention is to enable a vehicle manufacturer to offer his customers a larger choice of design possibilities in terms of the visual design of such strip components and hence an accompanying individualization. At the same time the intention is to make production of the strip component easier compared to the production of the strip component known from the prior art. The invention further provides a method for producing such a strip component.

For this purpose, it is proposed that: in order to produce the second visual appearance at least the second decorative surface portion be subjected to intermediate treatment by a treatment process which acts directly on the basic material itself and which serves to bring about a visual change in the surface of the second decorative surface portion compared to the first decorative surface portion, the intermediate treatment be either limited to the second decorative surface portion in its application or applied to the second decorative surface portion in a form differing from the first decorative surface portion, and the first decorative surface portion and the second decorative surface portion be subjected to uniform finishing by anodizing.

With regard to the production of such a strip component the following steps in the method are correspondingly proposed: modifying the surface condition of the second decorative surface portion through an intermediate treatment process acting directly on the basic material itself and either limited to the second decorative surface portion in its application or applied to the second decorative surface portion in a form differing from its application to the first decorative surface portion, bringing about a visual change in the surface of the second decorative surface portion compared to the first decorative surface portion, and subsequent uniform finishing of the surfaces of the first decorative surface portion and of the second decorative surface portion by anodizing.

The strip component accordingly comprises a decorative surface having a first decorative surface portion and a second decorative surface portion, which on the one hand have a different appearance because of the treatment process limited to the second decorative surface portion (intermediate treatment solely of the second decorative surface portion or both the second and at least a part of the first decorative surface portion, each in different forms), which serves to bring about a visual difference in the second decorative surface portion compared to the first decorative surface portion, but which have nevertheless both finally been subjected to uniform finishing by a method of anodizing, that is to say have been subjected to a uniform finishing affecting both decorative surface portions and applied uniformly to the surfaces of the basic material of both decorative surface portions, but which still reveals the previously applied intermediate treatment limited to the surface of the second decorative surface portion, even after application of the uniform finishing.

The intermediate treatment is preferably applied only to the second decorative surface portion. The possibility also fundamentally exists, however, of applying the same type of intermediate treatment to at least a part of the first decorative surface portion and to the second decorative surface portion, the application here being undertaken in a different form, however, in order to bring about a visual difference in the two decorative surface portions. A different form of the same intermediate treatment process occurs where the media, materials, tools, process parameters, etc. used in the intermediate treatment, which are employed for the second decorative surface portion, differ from those that are used for the first decorative surface portion, in such a way that a different visual appearance results in the second decorative surface portion compared to first decorative surface portion. Thus, for example, both decorative surface portions may be blasted with abrasive media (sand blasting, glass bead blasting, etc.), but different particle densities and/or particles sizes and/or particle energies, for example, may be used for the two decorative surfaces. Or the decorative surface portions may both be laser-irradiated but using laser beams with different radiation energies for the decorative surfaces. Or, if the decorative surface portions are both brushed, the second surface portion may be treated with harder and/or coarser brushes and/or with greater contact pressure.

The basic material of the strip component is the material forming the structure of the strip component and is preferably a light metal alloy, in particular an aluminum alloy suited to anodizing. The fact that the surface of the basic material itself contributes to the first visual appearance of the first decorative surface portion and the second visual appearance of the second decorative surface portion means, in particular, that the surface condition of a component surface formed by the basic material, in particular its roughness, gloss or surface texturing, plays a decisive role in determining the difference in the visual appearance of the first and second decorative surface portion. Consequently, the oxide layer of the basic material chemically converted close to the surface, and possibly dyed as a result of the anodizing process is also to be regarded as the surface of the basic material.

In spite of the final anodizing of the surfaces of both decorative surface portions, therefore, the visual appearance of both decorative surface portions is partially determined by the surface condition of a component surface which is formed by the basic material itself and which has also been visually modified by the intermediate treatment. A subsequent removal of some of an initially applied material layer (for example a coating, a layer of paint, an anodized coating), in order to expose the underlying visual appearance again, which has at first been concealed by the application of the material layer, is not necessary.

In producing the strip component, once forming of the semi-finished product has been completed, the surfaces both of the first decorative surface portion and of the second decorative surface portion are preferably uniformly pretreated by a method applied to both decorative surface portions, so that a uniform visual appearance is first imparted to the two surfaces of the respective decorative surface portions. This initially uniform appearance preferably at the same time determines the subsequent appearance of the first decorative surface portion or at least a substantial part thereof, since it is preferably further modified only in parts, if at all, prior to the uniform finishing. In particular, both decorative surface portions may first be ground (where this necessary as the first step in a surface treatment prior to polishing) and then polished. Without further change, the polished surface of the first decorative surface portion then preferably also forms the surface, or at least a part of the surface, which is subjected to the uniform finishing.

At least the second decorative surface portion is then subjected to the intermediate treatment. This treatment process, which acts directly on the basic material visually modifying the surface condition close to the surface, is preferably a treatment process, which increases the roughness of the surface of the second decorative surface portion and/or at least reduces the gloss of the second decorative surface portion. Possibilities here include, in particular, methods acting mechanically on the surface of the second decorative portion, such as sand blasting, glass bead blasting, brushing or grinding. Methods can also be used, however, which act without coming into contact with the surface of the second decorative surface portion, such as treating the surface of the second decorative surface portion by a non-contact method of irradiation with high-energy radiation such as plasma irradiation or laser irradiation, for example, including laser texturing. In this way it is possible to achieve a significant reduction in the surface gloss or even to purposely introduce a surface texture. (Electro)chemical methods such as etching of the surface formed by the basic material, for example, or a fluid-mechanical treatment, may also be used.

If it is to be ensured that only the second decorative surface portion is subjected to the intermediate treatment, and the first decorative surface portion is not affected by the treatment process, the first decorative surface portion may be masked by a masking during the intermediate treatment, for example by a precise application of a masking film covering and protecting the first decorative surface portion, which serves effectively to prevent the intermediate treatment process applied to the second decorative surface portion from acting on the first decorative surface portion.

It is also possible, however, for the intermediate treatment to be applied to at least a part of the first decorative surface portion and to the second decorative surface portion and for the change in the second visual appearance as distinct from the first visual appearance to merge fluidly at least over a boundary area.

The use of masking film for masking the first decorative surface portion is obviously only necessary if the treatment process for treating the second decorative surface portion close to the surface cannot itself be applied with sufficient precision to the surface of the second decorative surface portion to be treated, without at the same time also affecting at least parts of the surface of the first decorative surface portion. A masking film may consequently be necessary in particular when it is intended to blast the second decorative surface portion with abrasive media (sand blasting, glass bead blasting, etc.). In the case of laser irradiation (including laser texturing) of the second decorative surface portion, on the other hand, the use of a masking film can sometimes be avoided, depending on the precision of the irradiation devices used.

In order to be able to fit a masking precisely on the first decorative surface portion and in particular in a manner forming a distinct boundary line with the second decorative surface portion to be treated, the strip component may comprise a depression or elevation running at least over portions and preferably continuously along the boundary line of the first decorative surface portion with second decorative surface portion. The strip component more preferably comprises a dividing groove running as depression along the boundary line. The depression or elevation may be introduced after applying the masking for accurate guiding of a cutting device, which parts the masking film along the boundary line and which serves to cut the masking film precisely along the boundary line. The masking can thus at first be easily applied to both decorative surface portions, in particular without having to work very precisely. The decorative surface is then parted by means of the cutting device to be guided along the boundary line and the area of the masking, which at first still covers the second decorative surface portion, is detached, whilst the area of the masking covering the first decorative surface portion remains adhering thereto.

After treatment of the second surface with the treatment process, the strip component is anodized. Where necessary, the oxide layer produced may be dyed before sealing. Due to the surface treatment process prior to anodizing and applied only or in a different form to the second decorative surface portion, the two decorative surface portions each have a different visual appearance. In particular, the first decorative surface portion may have a lustrous to high-gloss finish, whilst the second decorative surface portion has only a matt silk gloss or an entirely matt appearance.

### BRIEF DESCRIPTION OF THE DRAWINGS

In the drawings:

FIG. 1a shows a strip component after carrying out a pre-treatment,

FIG. 1b shows the strip component in FIG. 1b in cross section,

FIG. 2a shows the strip component after intermediate treatment and finishing, and

FIG. 2b shows the strip component in FIG. 2a in cross section.

### DETAILED DESCRIPTION

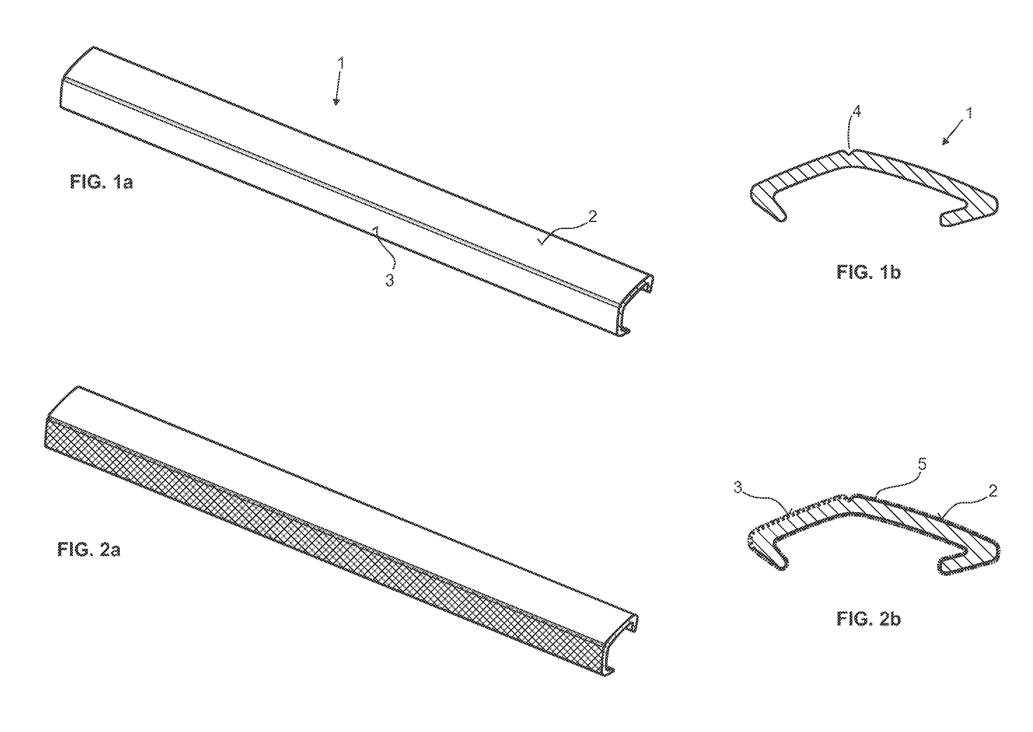

FIG. 1a shows a strip component 1, which is formed from an aluminum strip, which is designed to be mounted as trim strip on a preferably extruded profiled seal, together with which it may form a window channel cover strip, a window frame strip or a window surround, for example. The strip component 1 has a decorative surface which is visible when correctly fitted to the motor vehicle and which comprises a first decorative surface portion 2 and a second decorative surface portion 3.

To produce this as yet unfinished strip component a semi-finished aluminum product was subjected to a forming process. Then the entire decorative surface was ground and polished in a uniform step of the method, so that the first decorative surface portion 2 and the second decorative surface portion 3 have a uniform appearance and a uniform surface condition.

FIG. 2a shows the strip component 1 in figure la in the ultimately finished state ready for fitting. As can be seen from the cross-hatching in FIG. 2a, the surface of the second decorative surface portion 3 has a different visual appearance from the surface of the first decorative surface portion 2.

After grinding and polishing the strip component 1 shown in FIG. 1a the decorative surface comprising both decorative surface portions 2,3 has first been masked by a masking film. The masking film has then been cut along the dividing line with the aid of a dividing groove 4 (FIG. 1b and FIG. 2b), which runs exactly on the boundary between the first decorative surface portion and the second decorative surface portion and defines the boundary between the two decorative surface portions, and the masking left only on the first decorative surface portion. The dividing groove here assists the highly precise guiding of a cutting tool such as a knife blade even when this has to be guided manually owing to a complex profile or a complex geometry of the strip component.

The component surface forming the second decorative surface portion is then subjected to a treatment process which serves to modify the surface condition of the second decorative surface portion compared to the surface condition of the first decorative surface portion in a visually perceptible manner. This may involve, in particular, sand blasting the second decorative surface portion, so that the surface roughness of the second surface portion is increased in a distinctly visible way compared to the still polished surface of the first decorative surface portion. The masking film here prevents the intermediate treatment process being applied to the first decorative surface portion and ensures the limited application of the intermediate treatment solely to the second decorative surface portion.

Then, once the masking has been removed, the strip component is anodized and thus subjected to a finishing affecting all component surfaces of the strip component. In particular, the first and the second decorative surface portion undergo uniform finishing. In FIG. 2b the finishing is indicated schematically by the dot-and-dash line encompassing the cross section of the strip, which indicates an anodized coating 5 produced by the finishing. The surface condition produced by the intermediate treatment is represented in FIG. 2b by the dotted line symbolizing the second decorative surface portion.

For the sake of completeness, it should be noted that more than two decorative surface portions distinguishable through different visual appearances may obviously also be provided, a corresponding number of dividing grooves running along the boundary lines between these decorative surface portions then being provided.

### LIST OF REFERENCE NUMERALS

1 strip component
2 first decorative surface portion
3 second decorative surface portion
4 dividing line
5 anodized coating

The following is claimed:

1. A strip component (1) for a motor vehicle, the strip component (1) comprising:
an externally visible decorative surface when correctly fitted to the motor vehicle, wherein the decorative surface comprises at least a first decorative surface portion (2) having a first visual appearance and at least a second decorative surface portion (3) having a second visual appearance differing from the first visual appearance, wherein the strip component (1) is produced from a basic material and the surface of the basic material itself contributes both to the first visual appearance of the first decorative surface portion (2) and to the second visual appearance of the second decorative surface portion (3), wherein
in order to produce the second visual appearance at least the second decorative surface portion (3) is subjected to intermediate treatment by a treatment process which acts directly on the basic material and which serves to bring about a visual difference in the surface of the second decorative surface portion (3) compared to the first decorative surface portion (2),
the intermediate treatment is either limited to the second decorative surface portion (3) in its application or applied to the second decorative surface portion (3) in a form differing from the first decorative surface portion (2), and
the first decorative surface portion (2) and the second decorative surface portion (3) are subjected to uniform finishing by anodizing.

2. The strip component of claim 1, wherein the first decorative surface portion (2) is formed by a surface of the basic material that is first polished and then anodized.

3. The strip component of claim 1, wherein the second decorative surface portion (3) has a greater surface roughness and/or a reduced gloss compared to the first decorative surface portion (2).

4. The strip component of claim 1, wherein at least the second decorative surface portion (3) is blasted with abrasive media or is subjected to intermediate treatment by local heat or fluid-mechanical treatment.

5. The strip component of claim 1, wherein the strip component (1) comprises a depression or elevation running at least over portions along a boundary line between a first decorative surface portion (2) and a second decorative surface portion (3).

6. The strip component of claim 1, wherein the intermediate treatment is applied to at least a part of the first decorative surface portion (2) and to the second decorative surface portion (3) and the change in the first visual appearance merges fluidly into the second visual appearance.

7. A method for producing a strip component (1), the strip component (1) having an externally visible decorative surface when correctly fitted to the motor vehicle, wherein the decorative surface comprises at least a first decorative surface portion (2) having a first visual appearance and at least a second decorative surface portion (3) having a second visual appearance differing from the first visual appearance, the method comprising:
modifying the surface condition of the second decorative surface portion (3) through an intermediate treatment acting directly on the basic material and either limited to the second decorative surface portion (3) in its application or applied to the second decorative surface portion (3) in a form differing from its application to the first decorative surface portion (2), bringing about a visual difference in the surface of the second decorative surface portion (3) compared to the first decorative surface portion (2), and
subsequent uniform finishing of the surfaces of the first decorative surface portion (2) and of the second decorative surface portion (3) by anodizing.

8. The method of claim 7, wherein the first decorative surface portion (2) and the second decorative surface portion (3) are pretreated by a uniform pre-treatment of the surfaces of both the first decorative surface portion (2) and the second decorative surface portion (3) before the intermediate treatment is applied to the second decorative surface portion (3).

9. The method of claim 7, wherein the first decorative surface portion (2) and the second decorative surface portion (3) are uniformly pretreated by polishing before the intermediate treatment is applied to the second decorative surface portion (3).

10. The method of claim 7, wherein a surface of the first decorative surface portion (2) produced by a pretreatment is subjected without further change to finishing by anodizing.

11. The method of claim 7, wherein the first decorative surface portion (2) is masked prior to the intermediate treatment of the second decorative surface portion (3).

12. The method of claim 11, wherein for masking a masking film is applied to at least the first decorative surface portion (2).

13. The method of claim 12, wherein prior to the intermediate treatment of the second decorative surface portion (3) the masking is cut along a boundary line running between the first decorative surface portion (2) and the second decorative surface portion (3).

14. The method of claim 7, wherein the second decorative surface portion (3) is subjected to intermediate treatment by a process that increases the surface roughness or reduces the gloss.

15. The method of claim 7, wherein the second decorative surface portion (3) is blasted with abrasive media or subjected to intermediate treatment by local heat or fluid-mechanical treatment.
